(19) United States
(12) Patent Application Publication
(10) Pub. No.: US 2024/0176588 A1
(43) Pub. Date: May 30, 2024

(54) OPERATION UNIT, PROCESSING DEVICE, AND OPERATION METHOD OF PROCESSING DEVICE

(71) Applicants: Preferred Networks, Inc., Tokyo (JP); NATIONAL UNIVERSITY CORPORATION KOBE UNIVERSITY, Hyogo (JP)

(72) Inventors: Gentaro WATANABE, Tokyo (JP); Junichiro MAKINO, Hyogo (JP)

(21) Appl. No.: 18/519,700

(22) Filed: Nov. 27, 2023

(30) Foreign Application Priority Data
Nov. 28, 2022 (JP) 2022-189519

(51) Int. Cl. G06F 7/544; G06F 5/01; G06F 7/485; G06F 7/487

(52) U.S. Cl. CPC G06F 7/5443; G06F 5/012; G06F 7/485; G06F 7/4876

(57) ABSTRACT

An operation circuit includes a plurality of multipliers each configured to multiply each of respective first mantissas of a plurality of first data to which a first common exponent is set as a common exponent, by each of respective second mantissas of a plurality of second data to which a second common exponent is set as a common exponent; and a first adder configured to add up a plurality of products calculated by the plurality of multipliers.

### CROSS-REFERENCE TO RELATED APPLICATIONS

The present application is based upon and claims priority under 35 U.S.C. § 119 to Japanese Patent Application No. 2022-189519 filed on Nov. 28, 2022, the entire contents of which are incorporated herein by reference.

### TECHNICAL FIELD

The present disclosure relates to an operation unit, a processing device, and an operation method of a processing device.

### BACKGROUND

In general, in digital signal processing executed by a processing device such as a central processing unit (CPU) and a graphics processing unit (GPU), operations are executed using fixed-point number data or floating-point number data. For example, a method has been known in which one block scale factor is provided for each block including multiple items of fixed-point number data, and common scaling is applied to the items of fixed-point number data of the block.

As compared to a floating-point operation unit that executes floating-point operations, a fixed-point operation unit that executes fixed-point operations is smaller in circuit size, lower in power consumption, and faster in operation speed, but lower in operational precision. Contrary, as compared to the fixed-point operation unit, the floating-point operation unit is higher in operational precision, but larger in circuit size, higher in power consumption, and slower in operation speed.

### SUMMARY

According to an embodiment in the present disclosure, an operation circuit includes a plurality of multipliers each configured to multiply each of respective first mantissas of a plurality of first data to which a first common exponent is set as a common exponent, by each of respective second mantissas of a plurality of second data to which a second common exponent is set as a common exponent; and a first adder configured to add up a plurality of products calculated by the plurality of multipliers.

### BRIEF DESCRIPTION OF THE DRAWINGS

FIG. 1 is a block diagram illustrating an example of an operation unit according to an embodiment in the present disclosure;

FIG. 2 is an explanatory diagram illustrating an example of a format of block floating-point number data used in operations executed by an inner-product operation unit in FIG. 1;

FIG. 3 is a block diagram illustrating an example of a processing device having the inner-product operation unit in FIG. 1;

FIG. 4 is a block diagram illustrating an example of a processing element in FIG. 3;

FIG. 5 is an explanatory diagram illustrating examples of mantissas input into an integer multiplier of the inner-product operation unit in FIG. 1;

FIG. 6 is a block diagram illustrating an example of an operation unit according to another embodiment in the present disclosure;

FIG. 7 is an explanatory diagram illustrating an example of a format of block floating-point number data used in operations executed by the inner-product operation unit in FIG. 6;

FIG. 8 is an explanatory diagram illustrating a relationship between shift codes and shift amounts illustrated in FIG. 6;

FIG. 9 is an explanatory diagram illustrating examples of mantissas input into the integer multiplier of the inner-product operation unit in FIG. 6;

FIG. 10 is a flow chart illustrating an example of operations executed by a processing device having the inner-product operation unit in FIG. 6;

FIG. 11 is a block diagram illustrating an example (comparative example) of an inner-product operation unit that executes an inner-product operation on floating-point number data;

FIG. 12 is a block diagram illustrating an example of a processing element in a processing device according to another embodiment in the present disclosure;

FIG. 13 is an explanatory diagram illustrating an example of a format of block floating-point number data generated by a block floating-point generator in FIG. 12;

FIG. 14 is an explanatory diagram illustrating an example of operations executed by the block floating-point generator and an extractor in FIG. 12; and

FIG. 15 is a block diagram illustrating an example of a configuration of a system that includes a computer on which the processing device illustrated in FIG. 3 is installed.

### DETAILED DESCRIPTION OF THE EMBODIMENTS

In the following, embodiments in the present disclosure will be described in detail with reference to the accompanying drawings. An arrow attached to a signal line indicates a transfer direction of a signal transmitted through the signal line, and a symbol ‘/’ attached to a signal line indicates that the signal line (signal) includes multiple signal lines.

According to an embodiment, an operation unit and a processing device that are capable of executing operations while suppressing increase in circuit size can be provided.

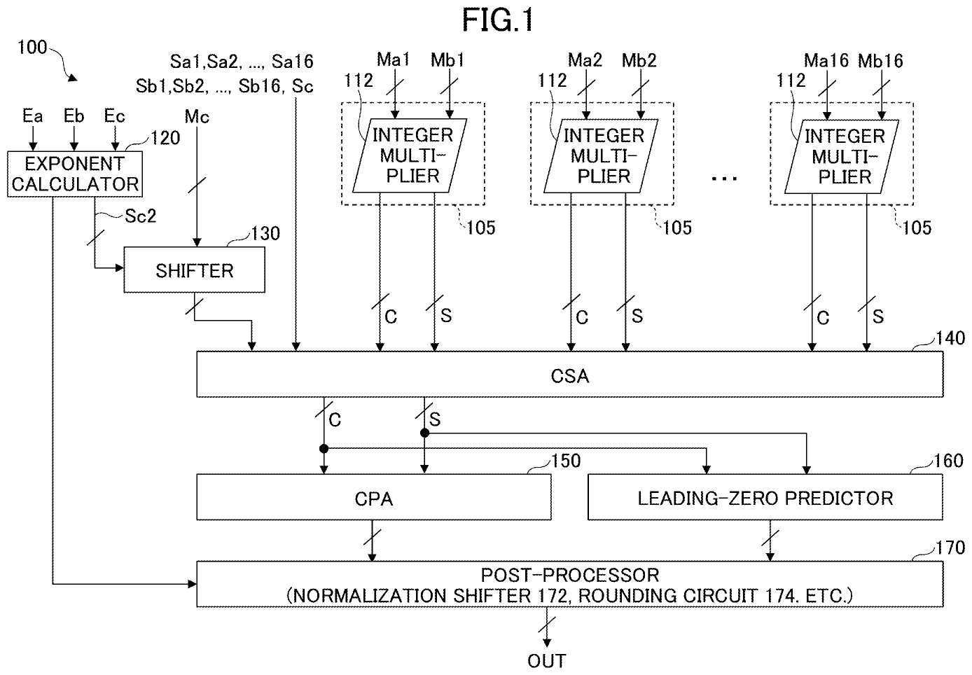

FIG. 1 is a block diagram illustrating an example of an operation unit according to an embodiment in the present disclosure. For example, an operation unit (or inner-product operation unit, an example of an operation circuit in the claims) 100 illustrated in FIG. 1 can be used as an inner-product operation unit that calculates the sum of products of multiple pairs of data. The inner-product operation unit 100 includes, for example, multiple multipliers 105 each including an integer multiplier 112, an exponent calculator 120, a shifter 130, a carry-save adder (CSA) 140, a carry-propagation adder (CPA) 150, a leading-zero predictor 160, and a post-processor 170.

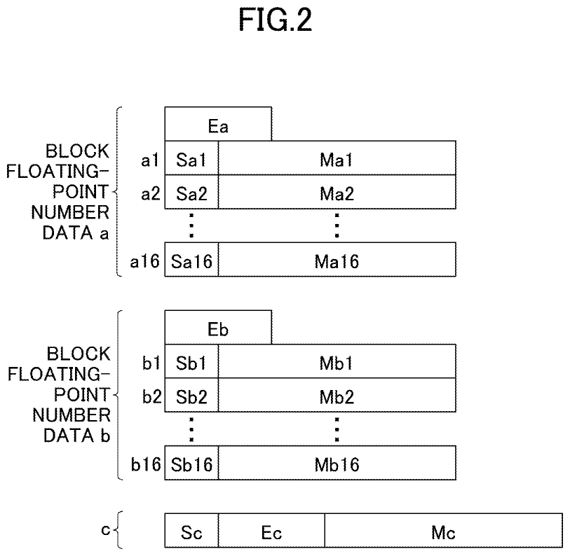

The inner-product operation unit 100 may calculate an inner product of multiple block floating-point number data a (a1, a2, . . . , am) and b(b1, b2, . . . , bm) where m is an integer greater than or equal to 2; the data format will be described with reference to FIG. 2. Note that the block floating-point number data a and b are fixed to have common exponents Ea and Eb for the data a and b, respectively.

Formula (1) shows an example of an inner-product operation in the case of m being ‘4’. In Formula (1), a symbol ‘*’ indicates a product (multiplication), and a symbol ‘c’ indicates data to be added to the result of the inner-product operation of the block floating-point number data a and b. For example, by having data c included in the result of the inner-product operation of the other block floating-point number data a and b, the inner-product operation independent of the number of multipliers 105 can be executed. a1*b1+a2*b2+a3*b3+a4*b4+c . . . (1) For example, the four multiplications in Formula (1) are executed in parallel, and then, the results of the four multiplications are added up together with the data c.

In the following description, although the inner-product operation unit 100 is assumed to have 16 units of multipliers 105, the number of multipliers 105 is not limited to 16 and simply needs to be two or more. In addition, in the following, the block floating-point number data a and b are also simply referred to as the data a and b. In addition, in the following, although detailed description of handling, rounding, and the like of the hidden bit in calculation of floating-point number data is omitted in some cases, it is assumed that the hidden bit is handled according to specifications such as IEEE (the Institute of Electrical and Electronics Engineers) 754 upon implementation.

FIG. 2 is an explanatory diagram illustrating an example of a format of block floating-point number data a and b used in operations executed by the inner-product operation unit 100 in FIG. 1. Each item of data a (a1, a2, . . . , a16) is represented by a corresponding sign bit Sa (Sa1, Sa2, . . . , Sa16), a corresponding mantissa Ma (Ma1, Ma2, . . . , Ma16), and a common exponent Ea. The common exponent Ea is set in common to 16 items of data a1-a16. Each item of data a is an example of first data, each mantissa Ma is an example of a first mantissa, and the common exponent Ea is an example of a first common exponent.

Each item of data b(b1, b2, . . . , b16) is represented by a corresponding sign bit Sb (Sb1, Sb2, . . . , Sb16), a corresponding mantissa Mb (Mb1, Mb2, . . . , Mb16), and a common exponent Eb. The common exponent Eb is set in common to 16 items of data b1-b16. Each item of data b is an example of second data, each mantissa Mb is an example of a second mantissa, and the common exponent Eb is an example of a second common exponent.

The items of data a1-a16 belong to one data block to which the common exponent Ea is set, and the items of data b1-b16 belong to another data block to which the common exponent Eb is set. For example, the number of items of data a belonging to one data block and the number of items of data b belonging to one data block are equal to the number of multipliers 105.

The data c is represented in, for example, the floating-point format of IEEE 754, and is represented by a sign bit Sc, an exponent Ec, and a mantissa Mc. The data c is an example of third data, and the mantissa Mc is an example of a third mantissa.

In the following, an example will be described in which the inner-product operation unit 100 executes an inner-product operation on block floating-point number data corresponding to floating-point number data of single precision. However, the inner-product operation unit 100 may execute an inner-product operation on block floating-point number data corresponding to floating-point number data of half precision, single precision, double precision, or any precision.

Referring back to FIG. 1, the integer multiplier 112 may include, for example, a Wallace Tree, to calculate the product of the mantissas Ma and Mb of the data a and b, and output the calculation result as a sum S and a carry C.

The exponent calculator 120 may calculate a shift amount Sc2 to be fed to the shifter 130, based on the common exponent Ea of the data a, the common exponent Eb of the data b, and the exponent Ec of the data c. For example, the shift amount Sc2 is calculated by a difference between the exponent Ec and the common exponent Ea+common exponent Eb (‘exponent Ec—(Ea+Eb)’). The shift amount Sc2 is an example of a third bit shift amount. In addition, the exponent calculator 120 may output the sum of the common exponent Ea and the common exponent Eb to the post-processor 170 as the exponent of the result of the inner-product operation. The sum of the common exponent Ea and the common exponent Eb output to the post-processor 170 is an example of a third common exponent that determines the radix point position of the mantissa as the result of addition by the CSA 140, and the exponent calculator 120 that calculates the sum of the common exponent Ea and the common exponent Eb is an example of a second adder.

In order to align the digit of the mantissa Mc of the data c with the digit of the multiplication result by the multiplier 105, the shifter 130 shifts the bit positions of the mantissa Mc in accordance with the shift amount Sc2, and output the shifted mantissas Mc to the CSA 140 on a scale representing the digit positions of data. The shifter 130 is an example of a second shifter.

The CSA 140 may calculate the sum (added value) of the multiplication result (S, C) by the multiplier 105 and the mantissa Mc after digit alignment by the shifter 130, by using the signs S (Sa1, Sa2, . . . , Sa16, Sb1, Sb2, . . . , Sb16, Sc) of the data a, b, and c. The CSA 140 may output the sum S and carry C obtained by the calculation to the CPA 150 and the leading-zero predictor 160. The CSA 140 is an example of a first adder.

The CPA 150 may add the sum S and the carry C calculated by the CSA 140, and output the result of addition (i.e., the result of the inner-product operation of the mantissa part) to the post-processor 170. Based on the sum S and the carry C calculated by the CSA 140, the leading-zero predictor 160 may calculate the number of ‘0’ continuously appearing on the higher-order bit side (i.e., the bit position at which ‘1’ first appears on the higher-order bit side). Then, the leading-zero predictor 160 may output information that indicates the calculated bit position to the post-processor 170.

The post-processor 170 includes, for example, a normalization shifter 172 and a rounding circuit 174. The normalization shifter 172 may normalize the result of addition by the CPA 150 according to the IEEE 754, based on the number of leading zeros calculated by the leading-zero predictor 160. In other words, the normalization shifter 172 may execute a shift operation for causing the most significant ‘1’ of the result of addition (mantissa) by the CPA 150 to become the hidden bit. The rounding circuit 174 may execute a rounding process on the normalized data. Then, the rounded result of the inner-product operation may have the exponent Ea+Eb adjusted according to the shift amount by the normalization shifter 172, and output as, for example, the floating-point number data OUT. Note that the post-processor 170 may output the operation result (OUT) in a format other than the floating-point number data. In addition, in FIG. 1, illustration of a block that calculates the sign of the floating-point number data OUT is omitted.

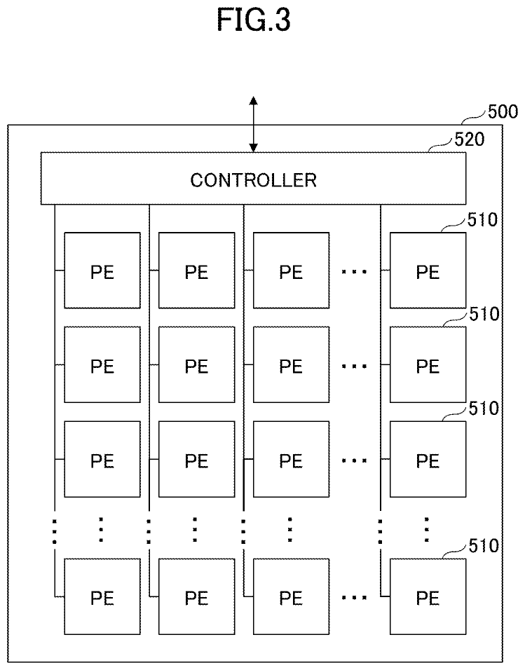

FIG. 3 is a block diagram illustrating an example of a processing device 500 having the inner-product operation unit 100 in FIG. 1. For example, the processing device 500 has a form of a semiconductor chip, and includes multiple processing elements (PEs) 510 and a controller 520 that controls operations of the processing elements 510. The processing device 500 may be included as part of a CPU or GPU, or may be included as part of a dedicated processor.

The processing device 500 may be used for deep learning or the like that uses a deep neural network (DNN) or a convolutional neural network (CNN). For example, the processing device 500 may be used for convolution processing in which multiple items of input data and multiple items of weight data are sequentially multiplied and added up.

Based on a command from an upper device (not illustrated) connected to the processing device 500, the controller 520 outputs, to the processing element 510, data to be operated by the processing element 510, control data necessary for execution of operations, and the like. The control data may include a command to start the operations. In addition, for example, the controller 520 receives the operation result from the processing elements 510, and outputs the received operation result to the upper device or stores the operation result in an external memory connected to the processing device 500.

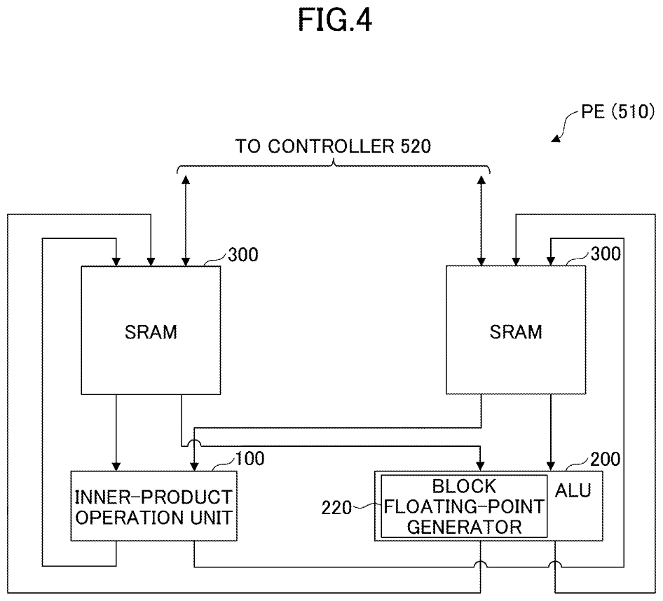

The multiple processing elements 510 execute operations in parallel based on the data and control data received from the controller 520, and output operation results to the controller 520. An example of the processing element (PE) 510 is illustrated in FIG. 4.

FIG. 4 is a block diagram illustrating an example of a processing element (PE) 510 in FIG. 3. Arrows connecting the blocks in FIG. 4 indicate signal lines that transfer data of multiple bits. In FIG. 4, illustration of the control signal is omitted. The processing element (PE) 510 includes, for example, the inner-product operation unit 100 illustrated in FIG. 1, an arithmetic and logic unit (ALU) 200, and multiple static random access memories (SRAMs) 300. The inner-product operation unit 100 may execute an inner-product operation using the data a, b, and c held in the SRAM 300, based on a command from the controller 520, and may store the execution result of the operations in the SRAM 300. For example, the SRAM 300 stores multiple sets of the date a, b, and c illustrated in FIG. 2.

The ALU 200 may execute an arithmetic operation, a logical operation, or the like by using data held in the SRAM 300, based on a command from the controller 520, and may store the execution result of the operation in the SRAM 300. In addition, the ALU 200 includes a block floating-point generator 220.

The block floating-point generator 220 converts a predetermined number of items of floating-point number data held in the SRAM 300 into block floating-point number data, for example, based on a command from the controller 520. For example, the block floating-point generator 220 generates a common exponent Ea (or Eb) to be commonly used for each data block that includes a predetermined number of items of floating-point number data. As the common exponent Ea (or Eb), the exponent of the maximum floating-point number data in the data block may be adopted. In other words, as the common exponents Ea (or Eb), the maximum values of the exponents of the maximum floating-point number data in the respective data blocks held in the SRAM 300 may be adopted.

In addition, the block floating-point generator 220 may generate a mantissa Ma (or Mb) of the block floating-point number data, based on the floating-point number data belonging to the data block and the common exponent Ea (or Eb). In other words, the block floating-point generator 220 may change each of the respective mantissas of items of the floating-point number data belonging to the data block, to the mantissa Ma (or Mb) in accordance with the common exponent Ea (or Eb).

For example, the mantissa Ma may be generated by shifting to the right by the number of bits corresponding to a difference between the common exponent Ea and the exponent of the original floating-point number data. The generation of the mantissa Mb may be executed in substantially the same way as the generation of the mantissa Ma. Note that in the maximum floating-point number data in the data block, the mantissa of the floating-point number data may be set as is to the mantissa Ma (or Mb) of the block floating-point number data.

Note that the block floating-point generator 220 may be arranged inside the processing element (PE) 510 and outside the ALU 200. In addition, part of the functions of the block floating-point generator 220 may be implemented by the controller 520, or may be implemented by software executed by an upper device or the like connected to the processing device 500. The number of SRAMs 300 installed on the processing element 510 is not limited to two. In addition, the SRAMs 300 may be used distinctively for the inner-product operation unit 100 and for the ALU 200, or may be used distinctively for types of items of data to be operated or the like.

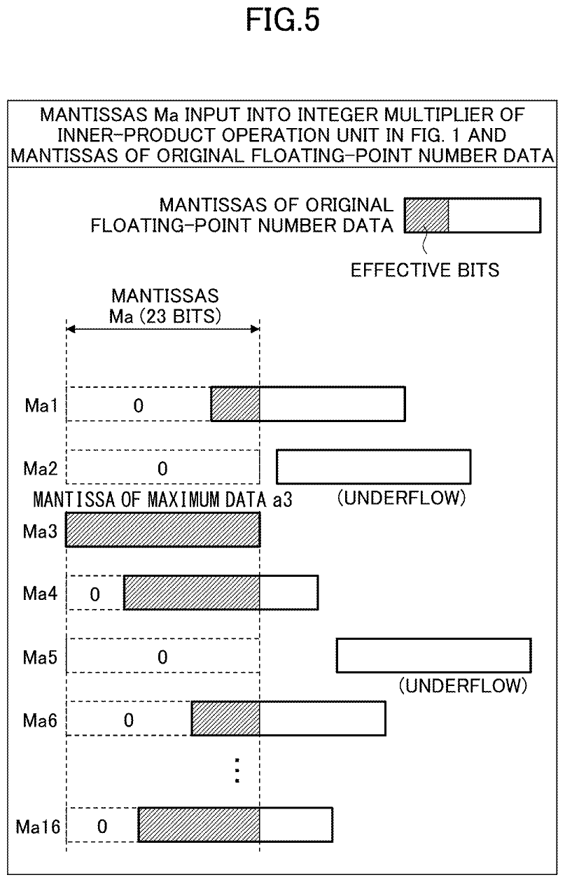

FIG. 5 is an explanatory diagram illustrating examples of mantissas input into the integer multiplier 112 of the inner-product operation unit 100 in FIG. 1. In FIG. 5, among the mantissas Ma and Mb input into the integer multiplier 112, the mantissa Ma is illustrated. In addition, although the mantissa Ma is assumed to have 23 bits in accordance with the data format, the number of bits is not limited to this number.

In the example illustrated in FIG. 5, it is assumed that the maximum value among 16 items of the data a1-a16 (not illustrated) is ‘a3’. For example, in this case, the exponent of the data a3 is set to the common exponent Ea, and the mantissas Ma1-Ma16 within a range (window) of 23 bits corresponding to the common exponent Ea on the scale representing the digit position of the data are input into the integer multipliers 112.

In the inner-product operation unit 100, among the mantissas of the original floating-point number data, mantissas do not fall within the 23-bit window are treated as underflow, and the value of the mantissas (e.g., Ma2 and Ma5) input into the inner-product operation unit 100 becomes ‘0’. In addition, among the mantissas of the original floating-point number data, mantissas that include fewer bits in the window (e.g., Ma1 and Ma6) have fewer effective bits of the mantissas input into the inner-product operation unit 100. Meanwhile, in the inner-product operation unit 100, the circuit size of the multiplier 105 is smaller than those of other inner-product operation units to be described later; therefore, the chip size can be reduced and the power consumption can be reduced. Alternatively, in the case of not reducing the chip size, the number of the inner-product operation units 100 that can be installed on one chip can be increased.

As above, in the embodiment illustrated in FIGS. 1 to 5, by multiplying the mantissas Ma and Mb bit-shifted based on the common exponents Ea and Eb by the integer multiplier 112, the multiplication result of the integer multiplier 112 can be supplied to the CSA 140 without bit-shifting. Therefore, an inner-product operation on multiple sets of data can be executed without providing a shifter for bit-shifting the multiplication result in the multiplier 105. As a result, as compared with the case of providing a shifter in the multiplier 105, the circuit size of the inner-product operation unit 100 can be reduced, the power consumption can be reduced, and the operation speed can be improved. Considering it simply, the effects of reducing the circuit size and the power consumption increase as the number of multipliers 105 installed on the inner-product operation unit 100 increases (i.e., as the number of items of the block floating-point number data a and b to which an inner-product operation is applied increases). However, the effects may be canceled depending on the size of a peripheral circuit and the like, and the appropriate number of multipliers 105 is determined by a specific circuit design.

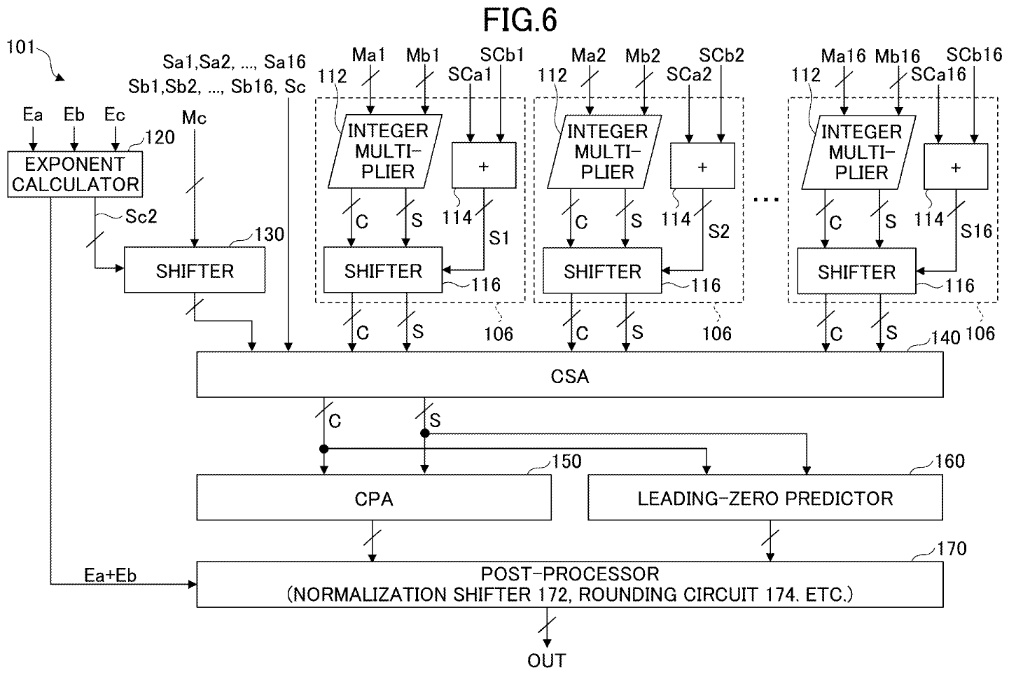

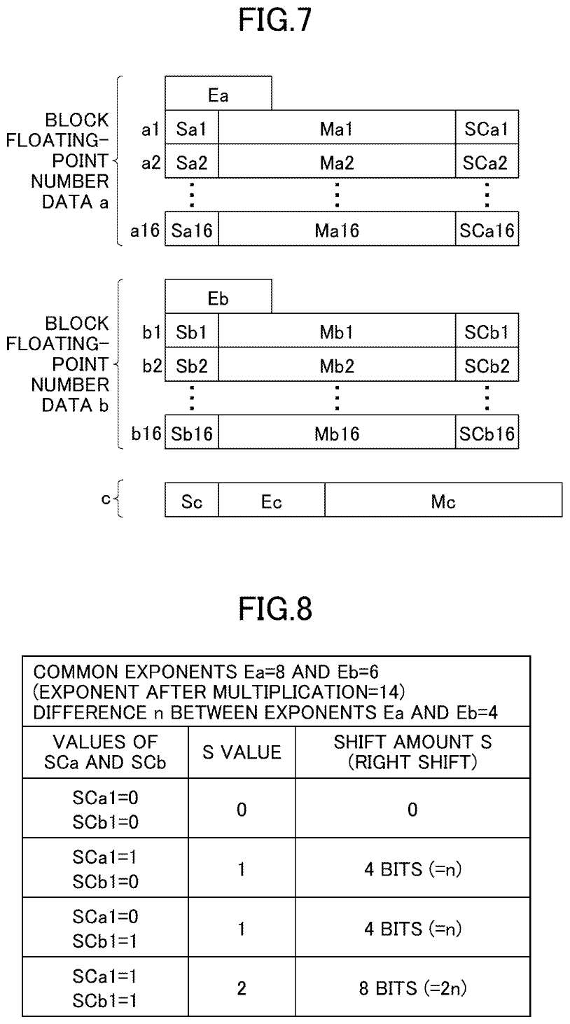

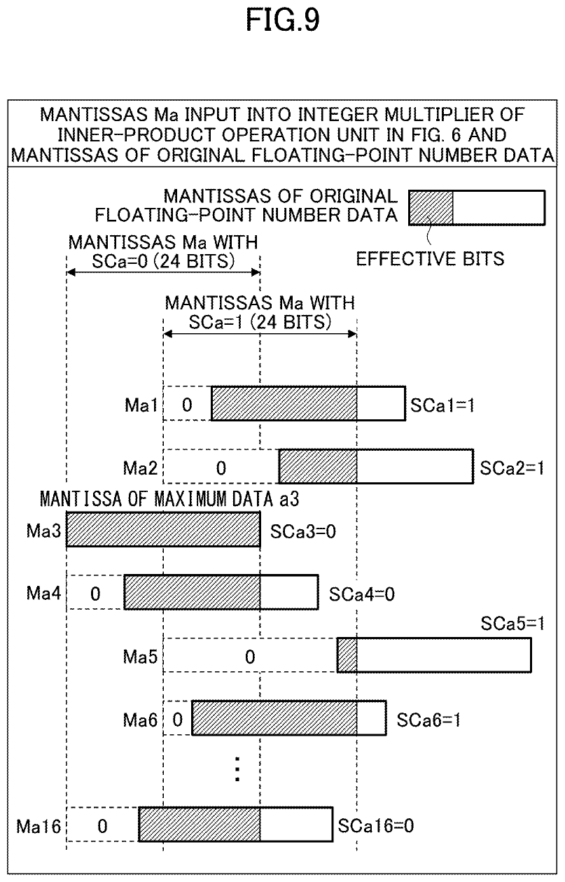

FIG. 6 is a block diagram illustrating an example of an operation unit according to another embodiment in the present disclosure. Elements similar to those in FIG. 1 are assigned the same reference numerals, and detailed description is omitted. An operation unit (or inner-product operation unit) 101 illustrated in FIG. 6 can be used as an inner-product operation unit that calculates the sum of products of multiple pairs of data, as in the case of the inner-product operation unit 100 illustrated in FIG. 1. For example, the inner-product operation unit 101 includes multiple multipliers 106, an exponent calculator 120, a shifter 130, a CSA 140, a CPA 150, a leading-zero predictor 160, and a post-processor 170.

Each of the multipliers 106 includes, for example, an integer multiplier 112, a shift amount calculator 114, and a shifter 116. The functions and operations of the exponent calculator 120, the shifter 130, the CSA 140, the CPA 150, and the post-processor 170 may be substantially the same as the functions and operations of the exponent calculator 120, the shifter 130, the CSA 140, the CPA 150, and the post-processor 170 illustrated in FIG. 1.

FIG. 7 is an explanatory diagram illustrating an example of a format of block floating-point number data a and b used in operations executed by the inner-product operation unit 101 in FIG. 6. Detailed description of the same contents as those in FIG. 2 are omitted. In this embodiment, the block floating-point numbers a and b may be substantially the same as those illustrated in FIG. 2, except that each of the block floating-point numbers a and b has a shift code SCa (SCa1, SCa2, . . . , SCa16) or SCb (SCb1, SCb2, . . . , SCb16). In the block floating-point number data a and b in this embodiment, an offset value with respect to the exponent can be selectively set from among multiple shift amounts (fixed values) determined in advance upon circuit design or the like. Specifically, by imposing a restriction on values that can be taken by the exponents (e.g., limiting to ‘2’, ‘4’, and, ‘6’, etc.), it can be implemented extremely compactly in terms of the circuit size of the shifter 116. How to use the shift codes SCa and SCb will be described later with reference to FIG. 8 and thereafter.

FIG. 8 is an explanatory diagram illustrating a relationship between the shift codes SCa and SCb and the shift amounts S (S1-S16) illustrated in FIG. 6. Each of the shift codes SCa (SCa1-SCa16) is a code indicating a bit shift amount with respect to digit positions (bit range) of the mantissa Ma represented by the common exponent Ea on a scale representing digit position of data, and is an example of a first code. Each of the shift codes SCb (SCb1-SCb16) is a code indicating a bit shift amount with respect to digit positions (bit range) of the mantissa Mb represented by the common exponent Eb on a scale representing digit position of data, and is an example of a second code.

Although FIG. 8 illustrates an example of a relationship among the shift codes SCa1 and SCb1 corresponding to the data a1 and b1, the S value, and the shift amount S1 is illustrated, substantially the same relationship may hold for the other shift codes SCa2-SCa16 and SCb2-SCb16. In addition, in FIG. 8, a case of each of the shift codes SCa1 and SCb1 being one bit is illustrated. In the case of each of the shift codes SCa1 and SCb1 being one bit, there are three values of the S value and the shift amount S1. In the case of each of the shift codes SCa1 and SCb1 being two bit, there are seven values of the S value and the shift amount S1.

In this present embodiment, for example, the block floating-point generator 220 illustrated in FIG. 4 sets the exponent of the maximum data a in the data block to which the data a belongs to the common exponent Ea, and sets the exponent of the maximum data b in the data block to which the data b belongs to the common exponent Eb. In addition, for example, the block floating-point generator 220 sets the shift code SCa of the data a whose exponent difference from the exponent of the maximum data a is greater than or equal to a predetermined amount to ‘1’, and sets the shift code SCa of the data a whose exponent difference from the exponent of the maximum data a is smaller than the predetermined amount to ‘0’. For example, the block floating-point generator 220 sets the shift code SCb of the data b whose exponent difference from the exponent of the maximum data b is greater than or equal to a predetermined amount to ‘1’, and sets the shift code SCb of the data b whose exponent difference from the exponent of the maximum data a is smaller than the predetermined amount to ‘0’.

In the following, a case will be described in which the common exponent Ea is ‘8’, the common exponent Eb is ‘6’, and the difference n (the number of bits to be shifted) from the common exponent Ea (or Eb) indicated by the shift code SCa(or SCb) is four bits. The difference n is an example of a reference bit shift amount. Note that the values of the common exponents Ea and Eb are assumed to be unbiased real exponent values.

The shift code SCa=‘0’ indicates that the shift operation is not executed (0-bit shift), and the shift code SCa=‘1’ indicates the shift operation of the reference bit shift amount n (first bit shift amount). Similarly, the shift code SCb=‘0’ indicates that the shift operation is not executed (0-bit shift), and the shift code SCb=‘1’ indicates the shift operation of the reference bit shift amount n (second bit shift amount).

The S value is a code indicating the shift amount S1 output by the shift amount calculator 114 (FIG. 6) corresponding to the mantissas Ma1 and Mb1, and is the sum of the shift codes SCa1 and SCb1. The shift amount S1 by the shifter 116 is represented by a product of the S value and the difference n. In the example illustrated in FIG. 8, as the difference n=‘4’, the shift amount S1 is ‘0’ when the S value is ‘0’, ‘4’ when the S value is ‘1’, and ‘8’ when the S value is ‘2’.

The shift amount S1 indicates a bit shift amount (right shift) executed by the shifter 116 that is applied to a multiplication result of the integer multiplier 112. For example, as expressed in Formula (2), the shift amount S1 is generated by multiplying the sum of the shift codes SCa and SCb by the reference bit shift amount n, and takes a discrete value within a limited range.

Shift amount S1=(SCa+SCb)*n . . . (2) Note that the number of types of the shift amount S1 can be increased not only by increasing the number of bits of the shift codes SCa and SCb, but also by setting the difference n for each of the shift codes SCa and SCb.

Referring back to FIG. 6, the shift amount calculator 114 may add the shift codes SCa (SCa1, SCa2, . . . , SCa16) and SCb (SCb1, SCb2, . . . , SCb16), and may calculate shift amounts S (S1, S2, . . . , S16) corresponding to values obtained by the addition. Note that the shift amount calculator 114 may obtain the shift amounts S1-S16 by referring to a register or the like that stores the relationship between the shift codes SCa and SCb and the shift amounts S1-S16.

Each of the shifters 116 may shift the sum S and the carry C received from the integer multiplier 112 to the right (lower side) on the scale representing the digit position by the number of bits corresponding to the shift amounts S1-S16, and may output the shifted sum S and carry C to the CSA 140. The shifter 116 is an example of a first shifter.

For example, assume that the difference n set in advance to be used in calculation of the shift amount S1 is ‘12’. In this case, when both the shift codes SCa and SCb are ‘0’, the shift amount S1 is 0 bits. When one of the shift codes SCa and SCb is ‘1’, the shift amount S1 is 12 bits. When both the shift codes SCa and SCb are ‘1’, the shift amount S1 is 24 bits.

In this way, in the case where the shift codes SCa and SCb are represented by one bit, and the difference n is ‘12’, the shift amount S1 may be any one of ‘0’, ‘12’, and ‘24’. Therefore, the shifter 116 can be implemented by connecting multiplexers in two stages, where each multiplexer selects either 0-bit shift or 12-bit shift. In other words, the shifter 116 having a large shift amount can be implemented while suppressing increase in circuit size.

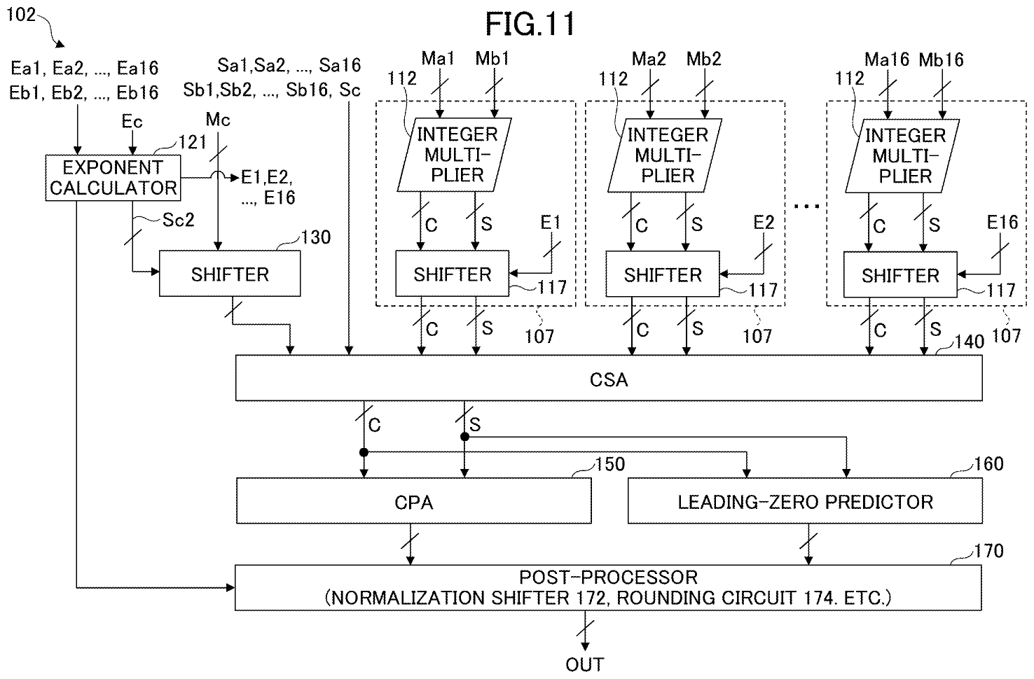

In contrast, in an inner-product operation unit that executes an inner-product operation of floating-point number data, a variable shifter for which the shift amount can be set in the unit of one bit is required. In this type of variable shifter, in the case of setting the maximum value of the shift amount to 31 bits, five stages of multiplexers are required, and in the case of setting the maximum value of the shift amount to 63 bits, six stages of multiplexers are required. The inner-product operation unit that executes an inner-product operation on floating-point number data is illustrated in FIG. 11.

Note that in the case where the shift amount S1 is the maximum value and the bit-shifted value of the product of the mantissas Ma1 and Ma2 is extremely small and negligible, the shifter 116 may output data representing ‘0’ without outputting data obtained by shifting the product of the mantissas Ma1 and Ma2. In this example, the maximum value of the shift amount S1 is ‘24’, which corresponds to the case where the S value in FIG. 8 is the maximum value (‘2’). For example, in the case where an output of ‘0’ is set by a mode register or the like provided in the processing element (PE) 510 illustrated in FIG. 4, the shifter 116 includes a gate circuit or the like that sets the output to the CSA 140 to ‘0’. Although it is necessary to add the gate circuit to the shifter 116, one stage of the multiplexer for shifting 12 bits is eliminated, the circuit size of the shifter 116 can be reduced.

In the inner-product operation unit 101 illustrated in FIG. 6, as compared with the inner-product operation unit of the floating-point number data, the number of stages of the multiplexers of the shifter 116 can be reduced to, for example, half or less. Accordingly, the circuit size of the multiplier 106 can be reduced, and the circuit size of the inner-product operation unit 101 can be reduced. As a result, the chip size of the processing device on which the inner-product operation unit 101 is installed can be reduced, and the cost of the processing device can be reduced. In addition, the number of stages of the multiplexer of the shifter 116 can be reduced; therefore, the operation speed can be improved, and the power consumption of the inner-product operation unit 101 can be reduced. Simply, the effect of reducing the circuit size and the power consumption increases as the number of pairs of mantissas Ma and Mb to be multiplied (i.e., the number of multipliers 106) increases.

Similar to the inner-product operation unit 100 illustrated in FIG. 1, the inner-product operation unit 101 illustrated in FIG. 6 may be installed on each of the multiple processing elements (PEs) 510 included in the processing device 500 illustrated in FIG. 3. Each processing element 510 may have the inner-product operation unit 101 instead of the inner-product operation unit 100 illustrated in FIG. 4, or the inner-product operation unit 100 and the inner-product operation unit 101 may be installed together.

Note that the processing element 510 having the inner-product operation unit 101 has substantially the same configuration and functions as those of the processing element 510 illustrated in FIG. 4 except that a function of generating the shift codes SCa and SCb is added to the block floating-point generator 220 of the processing element 510 illustrated in FIG. 4.

The block floating-point generator 220 according to this embodiment may generate the shift code SCa (or SCb) for each item of data a (or data b) based on the common exponent Ea (or Eb) and the exponent of each floating-point number data calculated in substantially the same way as in the block floating-point generator 220 of the embodiment described above. Then, the block floating-point generator 220 may store the generated common exponent Ea (or Eb), mantissa Ma (or Mb), shift code SCa (or SCb), and sign bit Sa (or Sb) in the SRAM 300. As the sign bit Sa (or Sb), the sign of the original floating-point number data may be used. The block floating-point generator 220 is an example of a data generator that generates the common elements Ea and Eb, the mantissas Ma and Mb, and the shift codes SCa and SCb.

FIG. 9 is an explanatory diagram illustrating examples of mantissas input into the integer multiplier 112 of the inner-product operation unit 101 in FIG. 6. Detailed description of the same contents as those in FIG. 5 are omitted. The mantissa Ma is illustrated also in FIG. 9, among the mantissas Ma and Mb that are input into the integer multiplier 112, and the mantissas Ma and Mb are assumed to be 24 bits. The 24-bit mantissa Ma of the inner-product operation unit 101 corresponds to the 23-bit mantissa and the hidden bit of the single-precision floating-point number data.

In addition, also in the example illustrated in FIG. 9, it is assumed that the maximum value among 16 items of the data a1-a16 (not illustrated) is ‘a3’. In this case, in the inner-product operation unit 101, the exponent of data a3 is set to the common exponent Ea. Then, similar to the inner-product operation unit 100 illustrated in FIG. 1, in the case where the shift code SCa is ‘0’, the mantissa Ma within the range (window) of 23 bits corresponding to the common exponent Ea is input into the integer multiplier 112. On the other hand, in the case where the shift code SCa is ‘1’, the mantissa Ma within a range obtained by shifting the range (window) of 23 bits corresponding to the common exponent Ea to the right (lower side) by the difference n set in advance (e.g., 12 bits) is input into the integer multiplier 112.

In the inner-product operation unit 101 illustrated in FIG. 6, the shift code SCa (‘0’ or ‘1’) is set for each mantissa Sa (Ma1, Ma2, . . . . , Ma16) according to the size of the original floating-point number data (exponent value). Then, in the case where the shift code SCa is ‘1’, bits included in a window shifted to the right by the difference n set in advance (e.g., 12 bits) are input into the inner-product operation unit 100 as the mantissa Ma.

Accordingly, the inner-product operation unit 101 can execute multiplication without causing underflow in the mantissas Ma2 and Ma5 (FIG. 5) that are underflowed in the inner-product operation unit 100 in FIG. 1. In other words, the narrow dynamic range of the block floating-point number data can be expanded. In addition, the number of effective bits of the mantissas Ma1 and Ma6 that have a smaller number of effective bits in the inner-product operation unit 100 can be increased. Further, for the mantissas Ma3, Ma4, and Ma16 whose shift code SCa is ‘0’, the number of effective bits can be the same as in the inner-product operation unit 100 in FIG. 1.

Also for the mantissa Mb whose window can be shifted to the lower bit side by the shift code SCb, the possibility of occurrence of underflow can be reduced, and the number of effective bits can be increased as in the case of the mantissa Ma. In addition, the number of stages of the shifter 116 can be reduced. As a result, in the inner-product operation unit 101 illustrated in FIG. 6, the precision of the inner-product operation can be improved while suppressing an increase in circuit size, an increase in power consumption, and a decrease in operation speed.

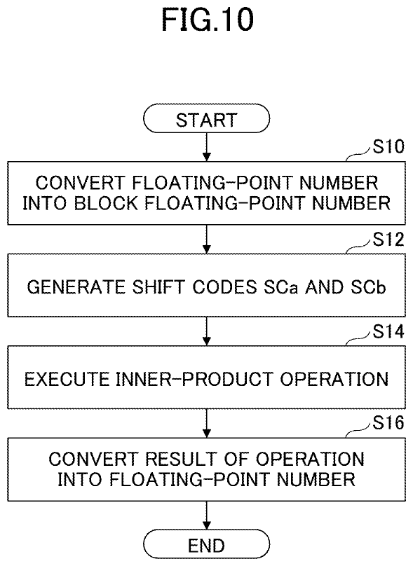

FIG. 10 is a flow chart illustrating an example of operations executed by the processing device 500 (FIG. 3) having the inner-product operation unit 101 in FIG. 6. In other words, FIG. 10 illustrates an operation method in the case where the inner-product operation unit 101 of the processing device 500 executes an inner-product operation. For example, the flow illustrated in FIG. 10 is started based on a command from an upper device connected to the processing device 500. The upper device has written floating-point number data (operands) to be used for the inner-product operation in the SRAM 300 (FIG. 5). FIG. 10 illustrates execution of one inner-product operation. For example, the operations illustrated in FIG. 10 may be executed in parallel in the multiple processing elements (PEs) 510 illustrated in FIG. 3.

First, at Step S10, the block floating-point generator 220 of the processing device 500 reads a predetermined number of items of floating-point number data from the SRAM 300 as a block, and may convert the read floating-point number data into block floating-point number data. Note that the floating-point number data corresponding to the data c in Formula (1) described above does not need to be converted into the block floating-point number data. The block floating-point generator 220 may store the converted block floating-point number data in the SRAM 300. Here, the block floating-point number data stored in the SRAM 300 includes, for example, the common exponents Ea and Eb, the mantissas Ma and Mb, the sign bits Sa and Sb, and the data c (floating-point number data Sc+Ec+Mc) illustrated in FIG. 7.

Next, at Step S12, the block floating-point generator 220 of the processing device 500 may generate the shift code SCa for each mantissa Ma, based on the common exponent Ea and the exponent of each of the original floating-point number data as described with reference to FIG. 8. Similarly, the block floating-point generator 220 may generate the shift code SCb for each mantissa Mb, based on the common exponent Eb and the exponent of each of the original floating-point number data. The block floating-point generator 220 may store the generated shift codes SCa and SCb in the SRAM 300. Note that Steps S10 and S12 may be executed in reverse order or in parallel.

Next, at Step S14, the inner-product operation unit 101 (FIG. 6) of the processing device 500 may read the block floating-point number data of the data a and b and the floating-point number data c held in the SRAM 300, to execute the inner-product operation. Next, at Step S16, the inner-product operation unit 101 may convert the result of the inner-product operation into floating-point number data, and store the converted data in the SRAM 300, to complete a single inner-product operation.

FIG. 11 is a block diagram illustrating an example (comparative example) of an inner-product operation unit that executes an inner-product operation on floating-point number data. Elements similar to those in FIG. 6 are assigned the same reference numerals, and detailed description are omitted.

Illustrated in FIG. 11, the inner-product operation unit 102 includes multiple multipliers 107, an exponent calculator 121, a shifter 130, a CSA 140, a CPA 150, a leading-zero predictor 160, and a post-processor 170. Each of the multipliers 107 includes an integer multiplier 112 and a shifter 117.

The inner-product operation unit 102 calculates an inner product of multiple floating-point number data a (a1, a2, . . . , am) and b (b1, b2, . . . , bm), where m is an integer greater than or equal to 2. This example of an inner-product operation is the same as Formula (1) except that the data is floating-point number data rather than block floating-point number data.

The integer multiplier 112 calculates the product of the mantissas Ma and Mb of the data a and b, and outputs the calculation result as a sum S and a carry C. The shifters 117 shift the sums S and the carries C received from the integer multipliers 112 to the right (lower side) by shift amounts indicated by the shift amounts E (E1, E2, . . . , E16) calculated by the exponent calculator 121, and output the shifted sums S and the shifted carries C to CSA 140.

For example, the shifter 117 is a variable shifter capable of setting the shift amount E in the unit of one bit. Therefore, in the case of setting the maximum value of the shift amount E to 31 bits, five stages of multiplexers are required, and in the case of setting the maximum value of the shift amount E to 63 bits, six stages of multiplexers are required. Therefore, the circuit size of the shifter 117 is larger than the circuit size of the shifter 116 in FIG. 1, and the power consumption of the shifter 117 is larger than the power consumption of the shifter 116 in FIG. 1. Further, the shift operation time of shifter 117 is longer than the shift operation time of shifter 116 in FIG. 1.

The exponent calculator 121 calculates the shift amounts E (E1-E16) to be fed to the shifters 117 for the respective multiplier 107, based on the exponents Ea (Ea1, Ea2, . . . , Ea16) of the data a and the exponents Eb (Eb1, Eb2, . . . , Eb16) of the data b. For example, the exponent calculator 121 sets, with reference to the maximum value of the sum Ea+Eb of the exponents, the difference between the sum Ea+Eb of the exponents other than the maximum value and the maximum value as the shift amount E (right shift) of the shifter 117. Accordingly, the digits of the multiplication results output from the multipliers 107 are aligned. Note that the shift amount E corresponding to the maximum value of the sum Ea+Eb is set to 0.

In addition, the exponent calculator 121 calculates the shift amount Sc2 of the exponent Ec, based on the exponents Ea (Ea1, Ea2, . . . , Ea16) of the data a, the exponents Eb (Eb1, Eb2, . . . , Eb16) of the data b, the exponent Ec of the data c. For example, the shift amount Sc2 indicates a difference between the maximum value of the sum of the exponents Ea+Eb and the exponent Ec. In addition, the exponent calculator 121 outputs the sum of the exponents Ea+Eb and the maximum value to the post-processor 170 as the exponent of the inner-product operation result.

In order to align the digit of the mantissa Mc of the data c with the digit of the multiplication result by the multiplier 106, the shifter 130 shifts the bit positions of the mantissa Mc in accordance with the shift amount Sc2, and output the shifted mantissas Mc to the CSA 140. The functions and operations of the CSA 140, the CPA 150, and the post-processor 170 may be substantially the same as the functions and operations of the CSA 140, the CPA 150, and the post-processor 170 illustrated in FIG. 1. Then, the post-processor 170 outputs the result of the inner-product operation based on the floating-point number data, for example, as the floating-point number data OUT. Note that in FIG. 11, illustration of a block that calculates the sign of the floating-point number data OUT is omitted.

As above, in the embodiment illustrated in FIGS. 6 to 10, the dynamic range of the mantissas Ma and Mb to be fed to the integer multiplier 112 can be widened, by setting the shift codes SCa and SCb indicating the difference between the common exponents Ea and Eb in the constraints defined in advance upon circuit design or the like.

Accordingly, the effective bits of the mantissas Ma and Mb can be increased to execute an inner-product operation. Therefore, for example, multiplication can be executed without underflow of the mantissas, and operational precision can be improved.

In addition, the number of shift amounts S1-S16 used by the shifter 116 can be limited; therefore, the number of stages of the multiplexers of the shifter 116 can be reduced as compared with the number of stages of the multiplexers of the shifter 117 provided in the inner-product operation unit 102 for floating-point number data. Therefore, an increase in circuit size can be suppressed, an increase in power consumption can be suppressed, and a decrease in operation speed can be suppressed, as compared to the inner-product operation unit 100 not including the shifter 116 illustrated in FIG. 1. In other words, the speed and precision of the inner-product operation can be improved while suppressing an increase in circuit size, an increase in power consumption, and a decrease in operation speed.

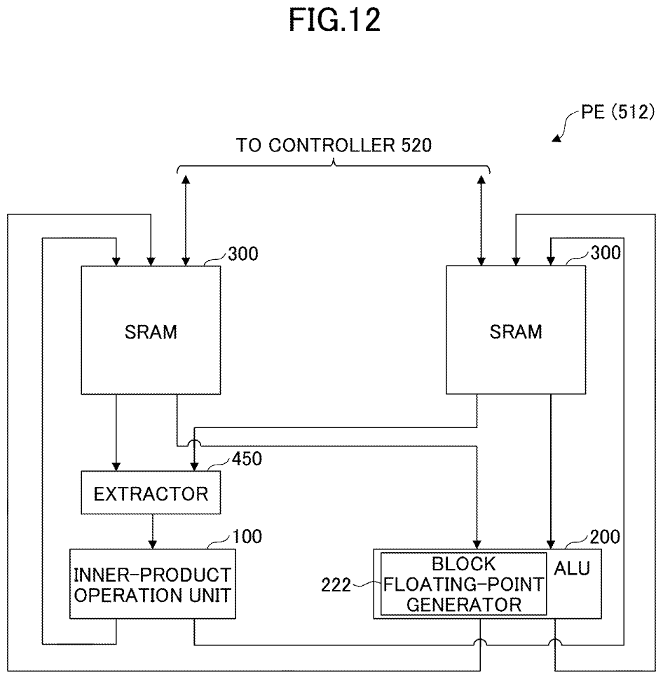

FIG. 12 is a block diagram illustrating an example of a processing element in a processing device according to another embodiment in the present disclosure. The processing device of this embodiment may be substantially the same as the processing device 500 illustrated in FIG. 3, except that the processing element (PE) 512 is different from the processing element 510 illustrated in FIG. 4. Note that the operation flow of the processing device of this embodiment may substantially the same as the operation flow in FIG. 10 except that the conversion method from the floating-point number data to the block floating-point number data at Step S10 in FIG. 10 is different.

In FIG. 12, an ALU 200 may include a block floating-point generator 222 instead of the block floating-point generator 220 illustrated in FIG. 4, and may additionally include an extractor 450. The other elements of the processing element 512 may be substantially the same as those of the processing element 510 illustrated in FIG. 4. Note that the block floating-point generator 222 may be arranged inside the processing element 512 (PE) and outside the ALU 200. In addition, part of the functions of the block floating-point generator 222 may be implemented by the controller 520 (FIG. 3), or may be implemented by software executed by an upper device or the like connected to the processing device 500.

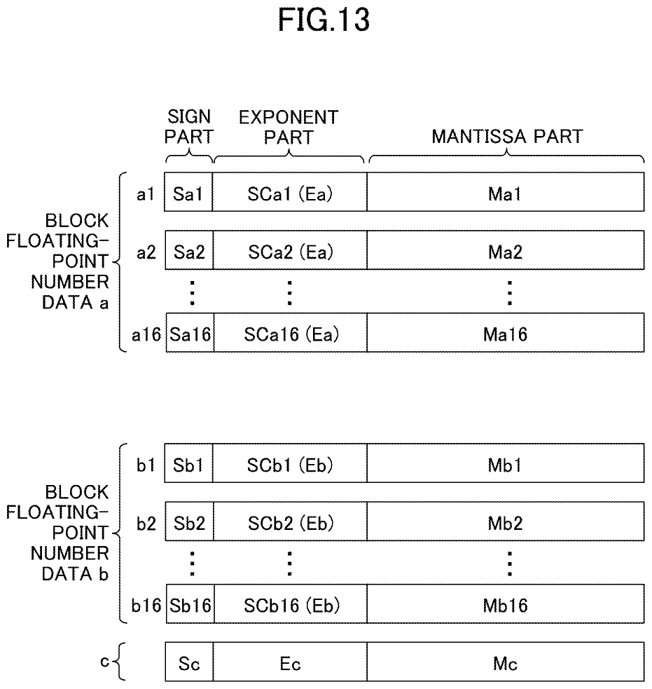

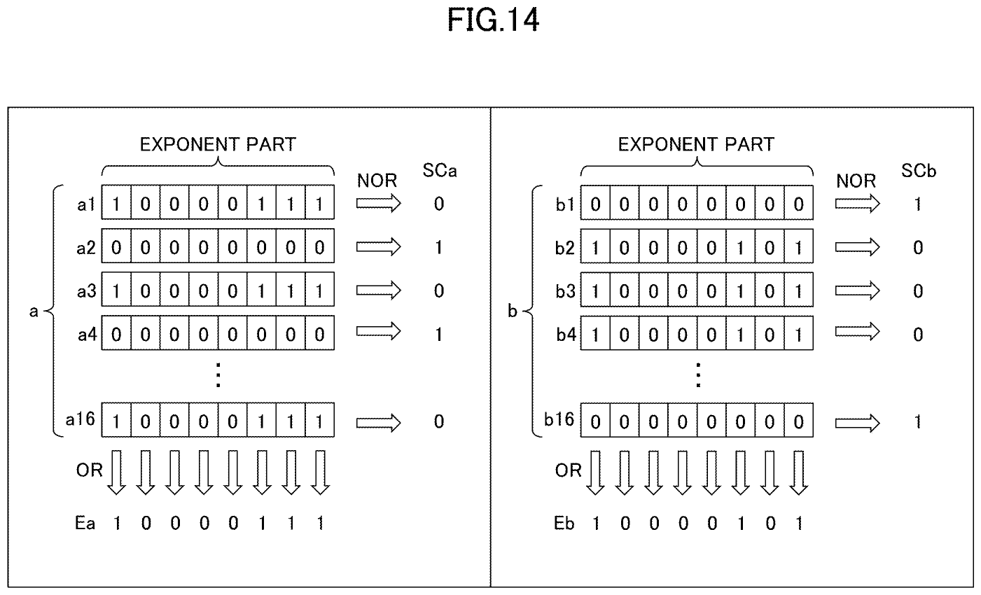

The block floating-point generator 222 converts a predetermined number of items of floating-point number data held in the SRAM 300 into block floating-point number data illustrated in FIG. 13, for example, based on a command from the controller 520 (FIG. 3). The converted block floating-point number data is stored in the SRAM 300. The extractor 450 reads the block floating-point number data from the SRAM 300, and extracts the common exponents Ea and Eb and the shift codes SCa and SCb. The extractor 450 may output the extracted common exponents Ea and Eb and shift codes SCa and SCb to the inner-product operation unit 100 together with the block floating-point number data read from the SRAM 300. Examples of extraction operations by the extractor 450 will be described with reference to FIG. 14.

FIG. 13 is an explanatory diagram illustrating an example of a format of block floating-point number data generated by the block floating-point generator 222 in FIG. 12. In this present embodiment, the format of the respective data a, b, and c corresponds to the format of the floating-point number data of IEEE 754. In other words, the respective numbers of bits and arrangement of the sign part, the exponent part, and the mantissa part of the block floating-point number data are the same as the format of the floating-point number data of IEEE 754. For example, in the case of single precision, the sign part is 1 bit, the exponent part is 8 bits, and the mantissa part is 23 bits.

However, the common exponent Ea may be embedded in at least one exponent part of the data a1-a16 in the data block, and the common exponent Eb may be embedded in at least one exponent part of the data b1-b16 in the data block. In this case, for example, for the data a1-a16 or the data b1-b16 in which Ea or Eb is not embedded, by not reading the exponent parts of the data, the power consumption can be reduced. In addition, for the data a1-a16 or the data b1-b16 in which Ea or Eb is not embedded, by treating the exponent parts as the mantissa part, the mantissa part can be lengthened and the calculation precision can be improved. In addition, for example, dispersing and embedding Ea (e.g., bit by bit) in any or all of the data a1-a16, and treating the exponent parts of the data a1-a16 in which Ea is not embedded as the mantissa part, the mantissa part can be lengthened and the calculation precision can be improved. Even if there is data that is not embedded, the mantissa part to be lengthened may be lengthened by the same number of bits as the number of bits of the embedded data so as to align the number of bits of the mantissa part. The same applies to Eb. In this case, for example, by not treating the unembedded exponent parts of the data a1-a16 as mantissa parts, and not reading the unembedded exponent parts of the data a1-a16 upon data reading, the power consumption can be reduced. By having the format of the block floating-point number data corresponding to the format of the floating-point number of IEEE 754, the conversion into the block floating-point number data can be simplified, and handling of the block floating-point number data can be simplified (e.g., processing by software).

FIG. 14 is an explanatory diagram illustrating an example of operations executed by the block floating-point generator 222 and an extractor 450 in FIG. 12. FIG. 14 illustrates the exponent part in FIG. 13. In the example illustrated in FIG. 14, it is assumed that the maximum value in the data block to which data a belongs is data a3, and the maximum value in the data block to which data b belongs is data b2.

For example, the block floating-point generator 222 sets all 0's in the exponent part of the data a that has an exponent difference from the exponent (‘87’ in hexadecimal) of the data a3 as the maximum value is greater than or equal to a predetermined amount. In addition, the block floating-point generator 222 sets the exponent of the data a3 (i.e., the common exponent Ea) in the exponent part of the data a that has a exponent difference from the exponent of the data a3 is less than the predetermined amount. In the example illustrated in FIG. 14, all 0's are set in the exponent parts of the data a2 and a4 that have exponent differences greater than or equal to the predetermined amount, and the common exponent Ea is set in the exponent parts of the other data a1, a3, and a5-a16.

Similarly, the block floating-point generator 222 may set all 0's in the exponent part of the data b that has an exponent difference from the exponent (‘85’ in hexadecimal) of the data b2 as the maximum value is greater than or equal to a predetermined amount. In addition, the block floating-point generator 222 may set the exponent of the data b2 (i.e., the common exponent Eb) in the exponent part of the data b that has a exponent difference from the exponent of the data b2 is less than the predetermined amount. In the example illustrated in FIG. 14, all 0's are set in the exponent parts of the data b1 and b16 that have exponent differences greater than or equal to the predetermined amount, and the common exponent Eb is set in the exponent parts of the other data b2-b15. The exponent parts of the data a and b set by the block floating-point generator 222 may be stored in the SRAM 300 (FIG. 12) together with the sign parts and the mantissa parts illustrated in FIG. 13.

In the case where the inner-product operation unit 100 illustrated in FIG. 1 executes an inner-product operation using the block floating-point number data, the extractor 450 reads each value of the exponent part from the SRAM 300. The extractor 450 may execute a NOR operation on bits (bits arranged in the horizontal direction in FIG. 14) of the exponent part of each of the data a1-a16, to generate the shift code SCa of each of the data a1-a16. Accordingly, the shift code SCa of the data a1, a3, and a16 in which the common exponent Ea (‘87’ in hexadecimal) is set in the exponent part becomes ‘0’, and the shift code SCa of the data a2 and a4 in which all 0's are set in the exponent part becomes ‘1’. In other words, the extractor 450 may extract the shift code SCa for each of the data a depending on whether the exponent part of the data a is all 0's.

The extractor 450 may execute a NOR operation on bits (bits arranged in the horizontal direction in FIG. 14) of the exponent part of each of the data b1-b16, to generate the shift code SCb of each of the data b1-b16. Accordingly, the shift code SCb of the data b2-b15 in which the common exponent Eb (‘85’ in hexadecimal) is set in the exponent part becomes ‘0’, and the shift code SCb of the data b1 and b16 in which all 0's are set in the exponent part becomes ‘1’. In other words, the extractor 450 may extract the shift code SCb for each of the data b depending on whether the exponent part of the data b is all 0's.

In addition, the extractor 450 may generate the common exponent Ea by executing an OR operation on each bit number of the exponent parts for 16 items of the data a1-a16. The extractor 450 may generate the common exponent Eb by executing an OR operation on each bit number of the exponent parts for 16 items of the data b1-b16. In other words, the extractor 450 may calculate a logical sum of bit values for each bit number (for the bits arranged in the vertical direction in FIG. 14) of the exponent parts of the data a1-a16, and extract the calculated logical sum as the common exponent Ea. In addition, the extractor 450 may calculate a logical sum of bit values for each bit number (for the bits arranged in the vertical direction in FIG. 14) of the exponent parts of the data b1-b16, and extract the calculated logical sum as the common exponent Eb.

By the operations of the extractor 450 described above, the shift codes SCa and SCb and the common exponents Ea and Eb can be extracted from the exponent parts of the data a and b held in the SRAM 300 in the floating-point format. Accordingly, as described with reference to FIG. 13, handling of the block floating-point number data can be simplified (e.g., processing by software).

For the embodiment illustrated in FIGS. 12 to 14, a supplementary note is added as follows. (Note)

The data generator (222) sets all 0's in the exponent part of the first data having an exponent difference from the exponent of the maximum first data (a3) greater than or equal to a predetermined amount;
sets the first common exponent (Ea) in the exponent part of the first data having an exponent difference from the exponent of the maximum first data less than the predetermined amount;
sets all 0's in the exponent part of the second data having an exponent difference from the exponent of the maximum second data (b2) greater than or equal to the predetermined amount; and
sets the second common exponent (Eb) in the exponent part of the second data having an exponent difference from the exponent of the maximum second data less than the predetermined amount; and
the processing device further includes an extractor (450) configured to:
extract the first code (SCa) for each item of the first data depending on whether the exponent part of each item of the first data set by the data generator is all 0's;
extract the second code (SCb) for each item of the second data depending on whether the exponent part of each item of the second data is all 0's; calculate a logical sum of bit values for each bit number of the exponent parts of the multiple first data;
extract the calculated logical sum as the first common exponent;
calculate a logical sum of bit values for each bit number of the exponent parts of the multiple second data; and
extract the calculated logical sum as the second common exponent.

As above, also in the embodiment illustrated in FIGS. 12 to 14, substantially the same effects as those in the embodiment illustrated in FIGS. 6 to 10 can be obtained. For example, the dynamic range can be widened by setting the shift codes SCa and SCb indicating the difference between the common exponents Ea and Eb in the constraints defined in advance upon circuit design or the like, and the effective bits of the mantissas Ma and Mb can be increased to execute the inner-product operation. Accordingly, for example, multiplication can be executed without underflow of the mantissas, and operational precision can be improved. In addition, the number of stages of the multiplexers of the shifter 116 can be reduced as compared with the number of stages of the multiplexers of the shifter 117 provided in the inner-product operation unit 101 for floating-point number data. As a result, the speed and precision of the inner-product operation can be improved while suppressing an increase in circuit size, an increase in power consumption, and a decrease in operation speed.

Further, in the embodiment illustrated in FIGS. 12 to 14, by having the format of the block floating-point number data corresponding to the format of the floating-point number of IEEE 754, the conversion into the block floating-point number data can be simplified. In addition, handling of the block floating-point number data can be simplified (e.g., processing by software). Further, by devising values to be stored in the exponent parts of the data a1-a16 and b1-b16, the common exponents Ea and Eb and the shift codes SCa and SCb can be extracted by simple logical operations.

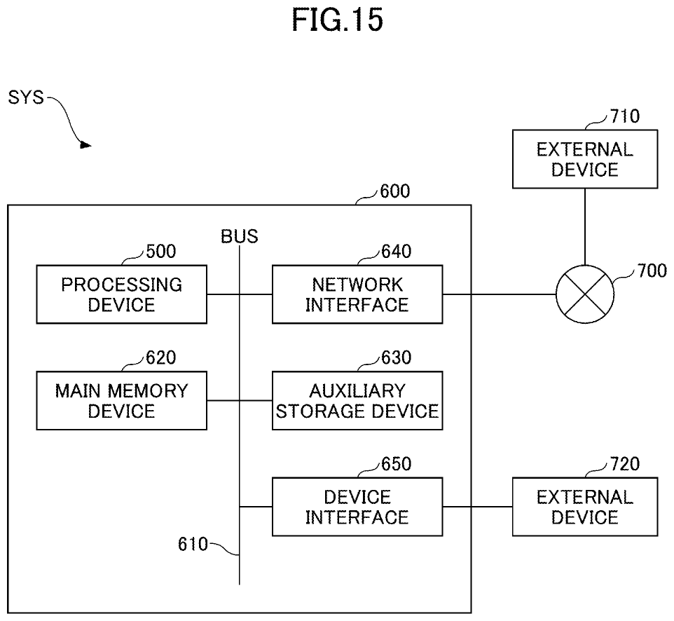

FIG. 15 is a block diagram illustrating an example of a configuration of a system SYS including a computer 600 on which the processing device 500 illustrated in FIG. 3 is installed. The computer 600 may be implemented, for example, to include the processing device 500, a main memory device 620 (memory), an auxiliary storage device 630 (memory), a network interface 640, and a device interface 650, and have these devices connected through a bus 610. Note that, for example, the processing device 500 may execute an inner-product operation based on instructions stored in a storage device such as the main memory device 620 or the auxiliary storage device 630.

Although the computer 600 in FIG. 15 is provided with one instance of each component, the computer 600 may be provided with multiple instances of each component. In addition, in FIG. 15, although one unit of the computer 600 is illustrated, the software may be installed in multiple computers, to have the multiple computers execute part of processes of the software that may be the same or different from one another. In this case, a form of distributed computing may be adopted in which the computers communicate with one another through the network interface 640 or the like to execute processing. In other words, a system may be configured in which functions are implemented by one unit or multiple units of the computers 600 executing instructions stored in one or more storage devices. In addition, an alternative configuration may be adopted in which information transmitted from a terminal is processed by one unit or multiple units of the computers 600 provided on a cloud, and processed results are transmitted to the terminal.

Various operations may be executed by parallel processing using one or more processing devices 500 installed on the computer 600, or using multiple computers 600 communicating with one another through a network. In addition, various operations may be allotted to multiple arithmetic/logic cores provided in the processing device 500, to be executed by parallel processing. Part or all of the processes, means, and the like in the present disclosure may be executed by at least one of processors and storage devices provided on a cloud that can communicate with the computer 600 through a network. In this way, the form of the operations by the processing device 500 may be a form of parallel computing executed by one or more computers.

The processing device 500 may be an electronic circuit that executes at least either control or arithmetic operations of a computer (a processing circuit, processing circuitry, CPU, GPU, FPGA, ASIC, etc.). In addition, the processing device 500 may be any of a general purpose processor, a dedicated processing circuit designed for executing specific operations, and a semiconductor device that includes both a general purpose processor and a dedicated processing circuit. In addition, the processing device 500 may include an optical circuit or an operational function based on quantum computing.

The processing device 500 may execute operations based on data input from devices as internal components of the computer 600 and software, and may output results of the operations and control signals to the respective devices and the like. The processing device 500 may execute an OS (Operating System), an application, and the like of the computer 600, to control the respective components that constitute the computer 600.

The processing device 500 may be implemented by one or more processing devices 500. Here, the processing device 500 may correspond to one or more integrated circuits arranged on one chip, or may correspond to one or more integrated circuits arranged on two or more chips or two or more devices. In the case of using multiple integrated circuits, the integrated circuits may communicate with each other by wire or wirelessly.

The main memory device 620 may store instructions to be executed by the processing device 500 and various items of data, and information stored in the main memory device 620 may be read by the processing device 500. The auxiliary storage device 630 may be a storage device other than the main memory device 620. Note that these storage devices may correspond to any electronic component that can store electronic information, and may be a semiconductor memory. The semiconductor memory may be either a volatile memory or a non-volatile memory. The storage device that stores various items of data in the processing device 500 may be implemented by the main memory device 620 or the auxiliary storage device 630, or may be implemented by a built-in memory built in the processing device 500.

In the case where the computer 600 is configured with at least one storage device (memory) and at least one processing device 500 connected (coupled) with this at least one storage device, at least one processing device 500 may be connected to at least one storage device. In addition, at least one processing device 500 may be connected to at least one storage device. In addition, a configuration in which at least one processing device 500 from among multiple processing device 500 is connected with at least one storage device (memory), may be included. In addition, a configuration may be implemented with storage devices and processing devices 500 included in multiple computers 600. Further, a configuration in which the storage device is integrated with the processing device 500 (e.g., a cache memory including an L1 cache and an L2 cache) may be included.

The network interface 640 is an interface to establish connection to a communication network 700 wirelessly or by wire. For the network interface 640, an appropriate interface such as an interface that conforms to an existing communication standard, may be used. Various types of data may be exchanged by the network interface 640 with an external device 710 connected through the communication network 700. Note that the communication network 700 may be any one or a combination of a WAN (Wide Area Network), a LAN (Local Area Network), a PAN (Personal Area Network), and the like, as long as the network is used to exchange information between the computer 600 and the external device 710A. One example of WAN is the Internet, one example of LAN is IEEE 802.11 and Ethernet (registered trademark), and one example of PAN is Bluetooth (registered trademark) and near field communication (NFC).

The device interface 650 is an interface that is directly connected with an external device 720, such as USB.

The external device 710 is a device connected to the computer 600 via a network. The external device 720 is a device directly connected to the computer 600.

The external device 710 or the external device 720 may be, for example, an input device. The input device may be, for example, a camera, a microphone, a motion capture, various sensors, a keyboard, a mouse, a touch panel, or the like, and provides the computer 600 with obtained information. Alternatively, the input device may be, for example, a device that includes an input unit, a memory, and a processor, such as a personal computer, a tablet terminal, or a smartphone.

Alternatively, the external device 710 or the external device 720 may be, for example, an output device. The output device may be, for example, a display device such as an LCD (Liquid Crystal Display) or an organic EL (Electro Luminescence) panel, or may be a speaker that outputs voice and the like. Alternatively, it may also be a device including an output unit, a memory, and a processor, such as a personal computer, a tablet terminal, or smartphone.

In addition, the external device 710 or the external device 720 may be a storage device (i.e., a memory). For example, the external device 710 may be a storage device such as a network storage, and the external device 720 may be a storage device such as an HDD.

In addition, the external device 710 or the external device 720 may be a device having some functions of the constituent elements of the computer 600. In other words, the computer 600 may transmit part of or all of results of processing executed to the external device 710 or the external device 720, or receive part of or all of results of processing executed from the external device 710 or the external device 720.

In the present specification (including the claims), the phrase “at least one of a, b, and c” or “at least one of a, b, or c” (including similar phrases) includes any of a, b, c, a-b, a-c, b-c, or a-b-c. Multiple instances may also be included in any of the elements, such as a-a, a-b-b, and a-a-b-b-c-c. Further, addition of another element other than the listed elements (i.e., a, b, and c), such as adding d as a-b-c-d, is included.

In the present specification (including the claims), in the case of using an expression such as “data as an input”, “using data”, “based on data”, “according to data”, or “in accordance with data” (including similar expressions), unless otherwise noted, a case in which data itself is used as an input, and a case in which data obtained by processing data (e.g., data obtained by adding noise, normalized data, a feature value extracted from data, and intermediate representation of data) is used as an input, are included. In addition, in the case where it is described that any result can be obtained “based on data”, “using data”, “according to data”, or “in accordance with data” (including similar expressions), a case in which the result is obtained based on only the data is included, and a case in which the result is obtained affected by data other than the data, factors, conditions, and/or states may be included. In the case where it is described that “data is output” (including similar expressions), unless otherwise noted, a case in which data itself is used as an output, and a case in which data obtained by processing data in some way (e.g., data obtained by adding noise, normalized data, a feature value extracted from data, and intermediate representation of various items of data) is used as an output, are included.

In the present specification (including the claims), in the case where terms “connected” and “coupled” are used, the terms are intended as non-limiting terms that include any of direct connection/coupling, indirect connection/coupling, electric connection/coupling, communicative connection/coupling, operative connection/coupling, and physical connection/coupling. Such a term should be interpreted according to a context in which the term is used, but a connected/coupled form that is not intentionally or naturally excluded should be interpreted as being included in the terms without being limited.

In the present specification (including the claims), in the case where an expression “A configured to B” is used, the meaning includes that a physical structure of an element A has a configuration that can execute an operation B, and that a permanent or temporary setting/configuration of the element A is configured/set to actually execute the operation B. For example, in the case where the element A is a general purpose processor, the processor may have a hardware configuration that can execute the operation B and be configured to actually execute the operation B by setting a permanent or temporary program (i.e., an instruction). In addition, in the case where the element A is a dedicated processor or a dedicated arithmetic/logic circuit, the circuit structure of the processor may be implemented so as to actually execute the operation B irrespective of whether control instructions and data are actually attached.

In the present specification (including the claims), the words “comprising” or “including” and “having” are intended to be open-ended terms that include or possess items other than those indicated by the object of the word. In the case where the object of the term indicating an inclusion or possession is an expression that does not specify a quantity or that suggests a singular number (i.e., an expression using “a” or “an” as an article), the expression should be interpreted as being not limited to a specific number.

In the present specification (including the claims), even if an expression such as “one or more” or “at least one” is used in a certain passage, and an expression that does not specify a quantity or that suggests a singular number (i.e., an expression using “a” or “an” as an article) is used in another passage, it is not intended that the latter expression indicates “one”. In general, an expression that does not specify a quantity or that suggests a singular number (i.e., an expression using “a” or “an” as an article) should be interpreted as being not necessarily limited to a particular number.

In the present specification, in the case where it is described that a particular effect (advantage/result) is obtained in a particular configuration included in an embodiment, unless there is a particular reason, it should be understood that that the effect can be obtained in one or more different embodiments having the configuration. It should be understood, however, that the presence or absence of the effect generally depends on various factors, conditions, states, and/or the like, and that the effect is not necessarily obtained by the configuration. The effect is merely to be obtained from the configuration described in the embodiment when various factors, conditions, states, and/or the like are satisfied, and is not necessarily obtained in the claimed inventive concept that defines the configuration or a similar configuration.

In the present specification (including the claims), in the case of using a term such as “maximize/maximization”, the meaning of the term includes determining a global maximum value, determining an approximate value of a global maximum value, determining a local maximum value, and determining an approximate value of a local maximum value, and the term should be interpreted as appropriate, depending on the context in which the term is used. The meaning also includes determining an approximate value of such a maximum value stochastically or heuristically. Similarly, in the case of using a term such as “minimize/minimization”, the meaning of the term includes determining a global minimum value, determining an approximate value of a global minimum value, determining a local minimum value, and determining an approximate value of a local minimum value, and the term should be interpreted as appropriate, depending on the context in which the term is used. The meaning also includes determining an approximate value of such a minimum value stochastically or heuristically. Similarly, in the case of using a term such as “optimize/optimization”, the meaning of the term includes determining a global optimum value, determining an approximate value of a global optimum value, determining a local optimum value, and determining an approximate value of a local optimum value, and the term should be interpreted as appropriate, depending on the context in which the term is used. The meaning also includes determining an approximate value of such an optimum value stochastically or heuristically.

In the present specification (including the claims), in the case where multiple hardware components executes predetermined processes, each of the hardware components may interoperate to execute the predetermined processes, or some of the hardware components may execute all of the predetermined processes. Alternatively, some of the hardware components may execute some of the predetermined processes while the other hardware components may execute the rest of the predetermined processes. In the present specification (including the claims), in the case where an expression such as “one or more hardware components execute a first process and the one or more hardware components execute a second process” is used, the hardware component that executes the first process may be the same as or different from the hardware component that executes the second process. In other words, the hardware component that executes the first process and the hardware component that executes the second process may be included in the one or more hardware components. The hardware component may include an electronic circuit, a device including an electronic circuit, and the like.

In the present specification (including the claims), in the case where multiple storage devices (memories) store data, each of the multiple storage devices may store only part of the data or may store the entirety of the data. Further, a configuration may be adopted in which some of the multiple storage devices store data.

As above, the embodiments of the present disclosure have been described in detail; note that the present disclosure is not limited to the individual embodiments described above. Various additions, modifications, substitutions, partial deletions, and the like may be made without departing from the conceptual idea and gist of the present disclosure derived from the contents defined in the claims and the equivalents thereof. For example, in the embodiments described above, numerical values or mathematical expressions used for description are presented as an example and are not limited thereto. In addition, the order of operations in the embodiments is presented as an example and is not limited thereto.

What is claimed is:

1. An operation circuit comprising:
a plurality of multipliers each configured to multiply each of respective first mantissas of a plurality of first data to which a first common exponent is set as a common exponent, by each of respective second mantissas of a plurality of second data to which a second common exponent is set as a common exponent; and
a first adder configured to add up a plurality of products calculated by the plurality of multipliers.

2. The operation circuit as claimed in claim 1, further comprising:
a second adder configured to add the first common exponent and the second common exponent, to generate a third common exponent that determines a radix point position of a mantissa as a result of addition of the first adder.

3. The operation circuit as claimed in claim 1, wherein each of the plurality of multipliers includes a first shifter configured to bit-shift a product calculated with a first bit shift amount including 0-bit shift selectively set according to a digit position of the first data from among a plurality of shift amounts defined in advance, and a second bit shift amount including 0-bit shift selectively set according to a digit position of the second data from among a plurality of shift amounts defined in advance.

4. The operation circuit as claimed in claim 3, wherein said each of the plurality of multipliers includes a shift amount calculator configured to calculate a product of a sum of a first code indicating the first bit shift amount and a second code indicating the second bit shift amount, and a reference bit shift amount, as a bit shift amount to be output to the first shifter.

5. The operation circuit as claimed in claim 4, wherein in a case where a sum of the first code and the second code indicates a maximum value, the first shifter outputs a value indicating ‘0’ instead of a value obtained by bit-shifting the calculated product.

6. The operation circuit as claimed in claim 2, further comprising:
an exponent calculator configured to calculate a third bit shift amount as a difference between a sum of the first common exponent and the second common exponent and an exponent of third data; and
a second shifter configured to shift a third mantissa of the third data according to the third bit shift amount,
wherein the first adder further adds the third mantissa bit-shifted by the second shifter to an added value of the plurality of products.

7. The operation circuit as claimed in claim 1, wherein the number of the plurality of multipliers and the number of the plurality of first data are the same.

8. The operation circuit as claimed in claim 1, wherein the number of the plurality of first data and the number of the plurality of second data are the same.

9. The operation circuit as claimed in claim 1, wherein the operation circuit is used for operations using a neural network.

10. A processing device comprising:
the operation circuit as claimed in claim 1; and
a block floating-point generator configured to:
set a maximum value of an exponent among a plurality of first floating-point number data as the first common exponent,
change respective mantissas of the plurality of first floating-point number data to the respective first mantissas in accordance with the first common exponent,
set a maximum value of an exponent among a plurality of second floating-point number data as the second common exponent, and
change respective mantissas of the plurality of second floating-point number data to the respective second mantissas in accordance with the second common exponent.

11. A processing device comprising:
an operation circuit,
wherein the operation circuit includes:
a plurality of multipliers each configured to multiply each of respective first mantissas of a plurality of first data to which a first common exponent is set as a common exponent, by each of respective second mantissas of a plurality of second data to which a second common exponent is set as a common exponent, and
a first adder configured to add up a plurality of products calculated by the plurality of multipliers.

12. The processing device as claimed in claim 11, wherein each of the plurality of multipliers includes a first shifter configured to bit-shift a product calculated with a first bit shift amount including 0-bit shift selectively set according to a digit position of the first data from among a plurality of shift amounts defined in advance, and a second bit shift amount including 0-bit shift selectively set according to a digit position of the second data from among a plurality of shift amounts defined in advance.

13. The processing device as claimed in claim 12, wherein said each of the plurality of multipliers includes a shift amount calculator configured to calculate a product of a sum of a first code indicating a first bit shift amount and a second code indicating a second bit shift amount, and a reference bit shift amount, as a bit shift amount to be output to the first shifter, and
wherein the processing device further includes a data generator configured to generate:
the first common exponent,
the first mantissas for each of the plurality of first data in accordance with the first common exponent,
the first code for each of the plurality of first data,
the second common exponent,
the second mantissas for each of the plurality of second data in accordance with the second common exponent, and
the second code for each of the plurality of second data,
from floating-point number data of the plurality of first data and the plurality of second data.

14. An operation method comprising:
multiplying, by a plurality of multipliers, each of respective first mantissas of a plurality of first data to which a first common exponent is set as a common exponent, by each of respective second mantissas of a plurality of second data to which a second common exponent is set as a common exponent; and
adding, by a first adder, a plurality of products calculated by a plurality of multipliers.

15. The operation method as claimed in claim 14, further comprising:
adding, by a second adder, the first common exponent and the second common exponent, to generate a third common exponent that determines a radix point position of a mantissa as a result of addition of the first adder.

16. The operation method as claimed in claim 14, wherein each of the plurality of multipliers includes a first shifter configured to bit-shift a product calculated with a first bit shift amount including 0-bit shift selectively set according to a digit position of the first data from among a plurality of shift amounts defined in advance, and a second bit shift amount including 0-bit shift selectively set according to a digit position of the second data from among a plurality of shift amounts defined in advance.

17. The operation method as claimed in claim 16, wherein said each of the plurality of multipliers includes a shift amount calculator configured to calculate a product of a sum of a first code indicating the first bit shift amount and a second code indicating the second bit shift amount, and a reference bit shift amount, as a bit shift amount to be output to the first shifter.

18. The operation method as claimed in claim 17, wherein in a case where a sum of the first code and the second code indicates a maximum value, the first shifter outputs a value indicating ‘0’ instead of a value obtained by bit-shifting the calculated product.

19. The operation method as claimed in claim 15, further comprising:
calculating, by an exponent calculator, a third bit shift amount as a difference between a sum of the first common exponent and the second common exponent and an exponent of third data; and
shifting, by a second shifter, a third mantissa of the third data according to the third bit shift amount,
wherein the first adder further adds the third mantissa bit-shifted by the second shifter to an added value of the plurality of products.

20. The operation method as claimed in claim 14, further comprising:
setting, by a block floating-point generator, a maximum value of an exponent among a plurality of first floating-point number data as the first common exponent;
changing, by a block floating-point generator, respective mantissas of the plurality of first floating-point number data to the respective first mantissas in accordance with the first common exponent;
setting, by a block floating-point generator, a maximum value of an exponent among a plurality of second floating-point number data as the second common exponent; and
changing respective mantissas of the plurality of second floating-point number data to the respective second mantissas in accordance with the second common exponent.
